(19) United States
(12) Patent Application Publication
(10) Pub. No.: US 2024/0035609 A1
(43) Pub. Date: Feb. 1, 2024

(54) BIMETALLIC PROTECTIVE SLEEVE FOR THE WELD SEAM OF CPSC PIPELINES

(71) Applicant: Sergei Viktorovich NOVIKOV, Samara (RU)

(72) Inventor: Sergei Viktorovich NOVIKOV, Samara (RU)

(21) Appl. No.: 18/201,848

(22) Filed: May 25, 2023

(30) Foreign Application Priority Data
Jul. 27, 2022 (RU) 2022120616

(51) Int. Cl. F16L 57/06; F16L 58/02

(52) U.S. Cl. CPC F16L 57/06; F16L 58/02

(57) ABSTRACT

The invention relates to the field of pipeline construction and repair, and in particular to a bimetallic protective sleeve for a weld seam of pipelines. The sleeve comprises a sleeve body, centering stops and two rubber collars. The sleeve body is made of stainless steel and configured as a ring having flared ends. The centering stops have a trapezoidal shape and evenly distributed along a transverse axis of symmetry of the sleeve body. The rubber collars are arranged symmetrically relative to the centering stops along the perimeter of the ends of the sleeve body. The technical result consists in increasing the reliability of the protective sleeve.

### FIELD OF THE INVENTION

The invention relates to the field of construction engineering and can be used in the construction and repair of pipelines intended for the transportation of oil, oil products, gases, various aggressive media, as well as for the transportation of water in cold and hot water supply systems of public utilities and in other areas. A bimetallic protective sleeve for a weld seam is configured to protect the internal weld seam from corrosion. The sleeve can be used when connecting pipelines in systems both during pipeline construction and, if necessary, repair works on pipeline sections.

### BACKGROUND OF THE INVENTION

RU 139694 U1 (published 20 Apr. 2014) discloses a sleeve for protecting the inside of a weld seam of a pipeline, which has an internal anti-corrosion coating. The sleeve is implemented as a pipe having flared ends and a stop ring arranged along the perimeter of the sleeve along the transverse axis of symmetry. The stop ring has trapezoidal stops. There are layers of thermoactive material arranged in the region of the ends, symmetrically around a central axis. The thermoactive material of the sleeve expands and foams at high temperature during welding, thereby completely filling an annular space and preventing transported liquids from contacting the weld seam and preventing corrosion development on the weld seam. This sleeve has significant disadvantages, namely: poor centering—it can be installed lopsidedly inside a pipe; and poor longitudinal stability inside the pipe, which causes the poor sealing of weld seams and the fragility of the structure as a whole.

RU 210525 U1 (published 19 Apr. 2022) discloses a protective sleeve for a weld seam of a pipeline, which has an internal anti-corrosion coating. The sleeve is implemented as a pipe having flared ends and a stop ring arranged along the perimeter of the sleeve along the transverse axis of symmetry. The stop ring has trapezoidal stops. There are layers of thermoactive foaming material in the region of the ends, symmetrically about a central axis. Additionally, there are rubber collars arranged along the perimeter of the ends of the sleeve, and the stop ring has an annular stiffening rib resting on the pipe. However, this sleeve suffers from the same disadvantages: poor centering—it can be installed lopsidedly inside the pipe; and poor longitudinal stability inside the pipe, which causes the poor sealing of weld seams and the fragility of the structure as a whole.

The above-indicated disadvantages are due to the sleeve design, i.e., the presence of the stops on the ring which impedes the proper centering of the sleeve body.

### SUMMARY OF THE INVENTION

It is an objective of the invention to eliminate the above-indicated disadvantages of the prior art. When implementing the purpose of the invention and implementing the above-indicated objective by the invention, a technical result is achieved, which consists in increasing the reliability of a protective sleeve.

The objective is implemented and the technical result is achieved by a bimetallic protective sleeve for a weld seam of pipelines, which comprises a sleeve body, centering stops and two rubber collars. The sleeve body is made of stainless steel and configured as a ring having flared ends. The centering stops have a trapezoidal shape and are evenly distributed along a transverse axis of symmetry of the sleeve body. The rubber collars are arranged symmetrically relative to the centering stops along the perimeter of the ends of the sleeve body.

In one embodiment, the centering stops may be made of carbon steel.

In one embodiment, the rubber collars may be made of oil and petrol resistant rubber.

### BRIEF DESCRIPTION OF THE DRAWINGS

The invention is explained by the drawings, in which:

FIG. 1 shows a cutaway front view of a bimetallic protective sleeve for a weld seam of a pipeline; and

FIG. 2 shows a cutaway side view of the bimetallic protective sleeve for the weld seam of the pipeline.

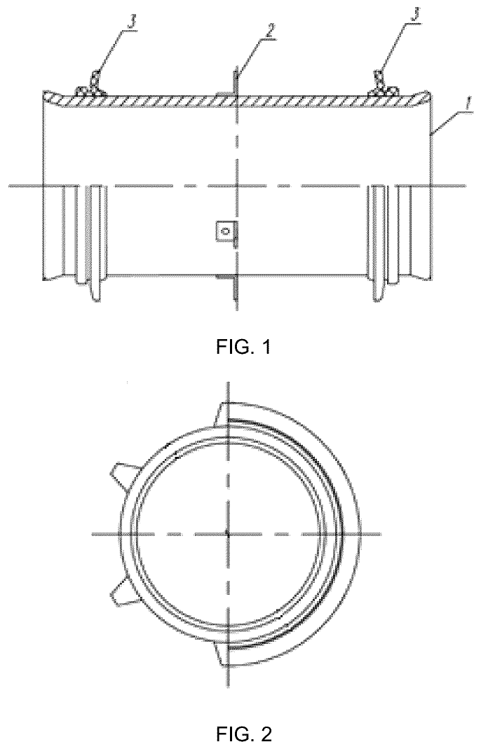

### DETAILED DESCRIPTION OF THE INVENTION

A bimetallic protective sleeve for a weld seam of a pipeline comprises a sleeve body 1, centering stops 2 and two rubber collars 3.

The sleeve body 1 is made of stainless steel in the form of a ring having flared ends. The centering stops 2 are made of carbon steel and have a trapezoidal shape, and are evenly distributed along the transverse axis of symmetry of the sleeve body 1. The rubber collars 3 are made of oil and petrol resistant rubber and are arranged symmetrically relative to the centering stops 2 along the perimeter of the ends of the sleeve body 1.

The number of the stops 2 varies depending on the diameter of the sleeve body 1. Their separate implementation (i.e., not on the ring, as in the prior art analogues) improves the centering of the device as a whole. Each of the stops works independently, and not as part of a stop ring, thereby making it possible to eliminate the lopsided arrangement of the sleeve body 1 inside a pipe. The stops 2 are made of a carbon steel sheet and have a trapezoidal shape. The presence of the stops 2 along the axis of symmetry of the sleeve body 1 allows the device to take a symmetrical position relative to the weld seam during installation. This makes it possible to effectively block the access of transported liquids to the weld seam on both sides of the device, and to ensure the transverse stability of the sleeve in the pipeline during its operation. Together with the rubber collars 3, the stops 2 improve the sealing of weld seams, since the collars serve to center the device along the axis of the pipeline and form a sealing bead from a sealant applied to the inner surface of the pipeline before installing the device. Thus, the combination of the constructive features of the invention improves the reliability of the protective sleeve.

The sleeve body 1 is made of a metal sheet of stainless steel, which prevents the application of anti-corrosion coatings on the sleeve and eliminates the risks of its thermal destruction during installation (welding process). This feature also improves the reliability of the protective sleeve.

The rubber collars 3 are made of oil and petrol resistant rubber and have a profile that allows the sleeve body 1 to be effectively centered relative to the axis of the pipeline having different wall thicknesses. During installation, the rubber collars 3 having such a profile form, in an annular space, a sealing bead from a sealant previously applied to the inner surface of the pipeline before mounting the sleeve to prevent the transported liquids from entering the annular space and prevent corrosion development on the weld seam.

Oil and petrol resistant rubber withstands temperatures ranging from −30 to +80 Celsius degrees. Petrol and oil products, when exposed to this material, do not affect its shape and elasticity properties.

The sleeve is bimetallic, i.e., the sleeve body is made of stainless steels, and the stops are made of carbon steels. This solution allows one not to apply an anti-corrosion coating on the sleeve and not to be afraid of thermal destruction of the anti-corrosion coating during welding.

The proposed design of the bimetallic protective sleeve for the weld seam of pipelines makes it possible to eliminate the disadvantages of the prior art, thereby achieving the technical result that consists in increasing the reliability of the protective sleeve.

The information search performed by using publicly available information sources has showed that the entire set of essential features of the bimetallic protective sleeve for the weld seam of pipelines is unknown from the prior art. For this reason, the invention meets the patentability requirement of “novelty”.

The bimetallic protective sleeve for the weld seam of pipelines is made from materials commonly used in this field of technology and by using well-known equipment. That is, it can be used in industry, which makes the invention meeting the patentability requirement of “industrial applicability”.

Upon considering the above-given description with the implementation example of the proposed bimetallic protective sleeve for the weld seam of pipelines, other changes, modifications and embodiments of the invention will become apparent to the ones skilled in the art. Thus, all such changes, modifications and embodiments, as well as other areas of use, which are not in contradiction with the essence of the invention, should be considered falling within the scope of the attached claims.

1. A bimetallic protective sleeve for a weld seam of pipelines, comprising:
a sleeve body;
centering stops; and
two rubber collars;
wherein the sleeve body is made of stainless steel and configured as a ring having flared ends;
wherein the centering stops have a trapezoidal shape and are evenly distributed along a transverse axis of symmetry of the sleeve body; and
wherein the rubber collars are arranged symmetrically relative to the centering stops along the perimeter of the ends of the sleeve body.

2. The sleeve of claim 1, wherein the centering stops are made of carbon steel.

3. The sleeve of claim 1, wherein the rubber collars are made of oil and petrol resistant rubber.
